(19) United States
(12) Patent Application Publication
(10) Pub. No.: US 2021/0205157 A1
(43) Pub. Date: Jul. 8, 2021

(54) Automated Adjustable Seating System

(71) Applicant: Therapeutic Comfort Pty Ltd., Malaga (AU)

(72) Inventor: Cary Nathan, Malaga (AU)

(73) Assignee: Therapeutic Comfort Pty Ltd., Malaga (AU)

(21) Appl. No.: 17/058,822

(22) PCT Filed: May 27, 2019
(86) PCT No.: PCT/AU2019/050523

§ 371 Date: Nov. 25, 2020

(30) Foreign Application Priority Data
May 27, 2018 (AU) 2018901856

(51) Int. Cl. A61G 5/10; A47C 1/024; A47C 7/50; A47C 7/72

(52) U.S. Cl. CPC A61G 5/1067; A47C 1/0242; A47C 7/5066; A61G 2203/74; A61G 5/107; A61G 2203/12; A61G 2203/34; A47C 7/727

(57) ABSTRACT

An automated adjustable seating system (10) comprising: a seat (16), the seat (16) incorporating a first sliding frame (62) and seat upholstery attached to the sliding frame (62); a backrest (20), the backrest (20) incorporating a second sliding frame (138) and back upholstery attached to the sliding frame (138); a set of actuators (106, 128, 194, 196, 198); and a control system (200). The set of actuators (106, 128, 194, 196, 198) includes an actuator for adjusting the angle of the seat (16) relative to the horizontal (194), an actuator (106) for adjusting the longitudinal position of the first sliding frame (62); an actuator (196) for adjusting the angle of the backrest (20) relative to the vertical and an actuator (198) for adjusting the longitudinal position of the second sliding frame (138). Each of the set of actuators (106, 128, 194, 196, 198) is controlled by the control system (200).

### FIELD OF THE INVENTION

The invention relates to an automated adjustable seating system. The invention is particularly suited for implementation as part of a wheelchair.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

The health and well-being of the elderly and infirm has become an issue of major importance in those countries—such as Australia—that have an ageing population. One particular problem associated with the care of such people is pressure injuries.

Pressure injuries can arise when a person has placed their weight on a surface for an extended period of time without shifting. In the case of the elderly and infirm, this often occurs when the person concerned is confined to their bed or a chair for the majority, if not all, of the day. Pressure injuries can also arise through “shear”, whereby the support surface moves relatively to the person's skin. The movement, coupled with friction between the support surface and the skin, can cause the skin to tear if the skin is softened and/or fragile, leading to an open wound.

One approach for dealing with the issue of pressure injuries is to have a care-giver move the person at set time periods so that their weight is shifted from one body area to another. However, this approach creates other problems in that it relies on the care-giver to have the necessary ability and skills—as well as be available—to move the person. Moving the person is also a time intensive task which has attendant financial consequences.

A second approach to dealing with pressure injuries is to use some sort of an adjustment system which automatically shifts the focus of the patient's weight. One example of such a system is the “Automated Adjustable Seating System” of US Patent Application 2016/0242548 in the name of Barnum, et. al. However, while adjustment systems such as that described in Barnum assist in resolving the issue of pressure injuries, they introduce the problem of shear.

When such a situation arises in an adjustable seating system (whether automated or not), the mere act of movement by one or more components of the adjustable seating system relative to another may therefore cause shear. If the person concerned is infirm or otherwise has limited means of communication, this could occur without notice by the care-giver, getting steadily worse until such time as it presents a significant health risk to the person. This is particularly the case with automated adjustment systems where the care giver may leave the person unattended for a significant period of time.

It is therefore an object of the present invention to produce an automated adjustable seating system that solves, or ameliorates at least in part, one or more of the aforementioned problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the invention there is an automated adjustable seating system comprising:

a seat, the seat incorporating a first sliding frame and seat upholstery attached to the sliding frame;

a backrest, the backrest incorporating a second sliding frame and back upholstery attached to the sliding frame;

a set of actuators; and

a control system

where the set of actuators includes an actuator for adjusting the angle of the seat relative to the horizontal, an actuator for adjusting the longitudinal position of the first sliding frame; an actuator for adjusting the angle of the backrest relative to the vertical and an actuator for adjusting the longitudinal position of the second sliding frame and where each of the set of actuators is controlled by the control system.

In a first variation, the control system operates to simultaneously control the actuator that adjusts the longitudinal position of the first sliding frame in a manner that counteracts the change in seat position caused when the control system operates to control the actuator for adjusting the angle of the seat relative to the horizontal so as to minimise any gap formed between the seat upholstery and back upholstery.

In a second variation, the control system may also operate to simultaneously control the actuator that adjusts the vertical position of the second sliding frame in a manner that counteracts the change in backrest position caused when the control system operates to control the actuator for adjusting the angle of the backrest relative to the vertical so as to minimise any gap formed between the seat upholstery and the back upholstery.

The invention may also include a leg rest and where the set of actuators further includes an actuator for adjusting the angle of the leg rest relative to the vertical.

The backrest and seat are, ideally, connected at a pivot point and where that adjustment of the angle of the backrest is made with reference to the vertical at the pivot point and where the adjustment of the angle of the seat is made with reference to the horizontal at the pivot point. Additionally, the seat upholstery has a first side and the back upholstery has a second side, the first side and the second side arranged to face each other and the profile of the first and second sides being such that the sides may rotate relative to each other without creating a substantial gap therebetween. Preferably, the first and/or second side, or both, has a rounded profile.

The invention may further incorporate a pair of seat arms, each seat arm rotationally connected to the seat and the backrest so that the arm is self-levelling regardless of the position of the seat relative to the backrest. The seat arm may be connected to the seat by way of a first rotational arm and connected to the backrest by way of a second rotational arm, the rotational arcs of the first rotational arm and second rotational arm being such as to ensure self-levelling of the arm regardless of the position of the seat relative to the backrest.

At least one actuator in the set of actuators incorporates a potentiometer, the potentiometer in data communication with the control system. Preferably, the control system operates to return at least one actuator in the set of actuators to a first set position on receiving a signal form a potentiometer indicating that the frame has made contact with an external object.

The actuators and/or the potentiometers may be in wireless data and control communication with the control system.

The adjustable seating system may further comprise a leg rest rotationally connected to the seat, one of the actuators in the set of actuators operable to adjust the angle of the leg rest relative to the seat. The leg rest may optionally incorporate a foot rest.

The adjustable seating system may also comprise a microswitch located between the seat and the backrest, the microswitch in data communication with the control system. The control system may operate to return the seat, the backrest or both the seat and the backrest to a predetermined position on receiving a signal from the microswitch indicating that something is lodged in a gap between the seat and the backrest. The microswitch may be in wireless data communication with the control system.

The seat and backrest ideally form part of a frame, the portion of the frame supporting the seat and the seat incorporate apertures to facilitate draining of any liquid spilt thereon.

A replaceable, rechargeable power unit can be used to supply power to the set of actuators and control system.

The back upholstery may incorporate speakers, the speakers in data and control communication with the control system. Preferably, the speakers are located within the back upholstery at a position proximate the expected head position of the average seated portion. This allows the delivery of music therapy in conjunction with the physical therapy provided by the adjustable seating system.

The control system may take the form of one or more of the following: a tablet; a smart phone; a notebook or laptop computer; a dedicated handset controller.

In a preferred arrangement, the control system is operable to:

(a) control the set of actuators to limit the angle between the seat upholstery and the backrest upholstery to 150°;

(b) control the set of actuators to limit the seat height to an angle of 5°;

(c) control the set of actuators to move the first sliding frame to a maximum of 13% of its maximum available movement;

(d) control the set of actuators to move the second sliding frame to a maximum of 70% of its maximum available movement;

(e) control the set of actuators to limit the angle between the leg rest and the seat upholstery to an angle of 70°.

In another configuration, at least one of the seat upholstery or the backrest upholstery has presence detecting means incorporated therein for detecting the presence, or absence, of a seated person, the presence detecting means being in data communication with the control system. The control system may operate to notify an external party, such as a care giver, on receiving a signal from the presence detecting means indicating that a previously seated person is no longer seated in the seating system.

The control system ideally operates to control the set of actuators to perform a set movement program. The set movement program may be a continuous movement program or a discontinuous movement program. Alternatively, or conjunctively, the set movement program may be customised for a set user. Customisation may be in respect of one or more of the following factors: duration of operation; range of movement; frequency of movement; type of movement; number of repetitive movement cycles; details of any interruptions to the set movement program.

The control system may periodically operate to send details of each set movement program executed by the automated adjustable seating system to a central repository for association with a patient's health record.

In accordance with a second aspect of the present invention there is a wheelchair incorporating the automated adjustable seating system of the first aspect of the invention.

### BRIEF DESCRIPTION OF THE SEVERAL VIEWS OF THE DRAWINGS

The invention will now be described, by way of example only, with reference to the accompanying drawings, in which:

FIG. 1 is a front isometric view of an adjustable seating system according to a first embodiment of the present invention with one side thereof removed to assist in visualisation.

FIG. 2 is a back isometric view of the adjustable seating system as shown in FIG. 1 with one side thereof removed to assist in visualisation.

FIG. 2A is a plan view of a cushioning arrangement as used in an adjustable seating system as shown in FIG. 1.

FIG. 3 is an isometric view of a base portion as used in an adjustable seating system as shown in FIG. 1.

FIG. 4 is a plan view of a wheel mount as forms part of the base portion as shown in FIG. 3.

FIG. 5 is an isometric view of a sliding frame forming part of a seat portion as used in an adjustable seating system as shown in FIG. 1.

FIG. 6 is an isometric view of a mounting frame forming part of a seat portion as used in an adjustable seating system as shown in FIG. 1.

FIG. 7 is an isometric view of a sliding frame forming part of a back portion as used in an adjustable seating system as shown in FIG. 1.

FIG. 8 is an isometric view of part of a slide plate forming part of the sliding frame as shown in FIG. 7.

FIG. 9 is a side view of the back portion, as assembled and used in an adjustable seating system as shown in FIG. 1.

FIG. 10 is an isometric view of a mounting frame forming part of the back portion as shown in FIG. 9.

FIGS. 11a, 11b and 11c are isometric views of the components that form the arm rests of an adjustable seating system as shown in FIG. 1.

FIG. 12 is a rear isometric view of an adjustable seating system according to a third embodiment of the present invention.

FIG. 13 is an isometric view of a base portion as used in the adjustable seating system as shown in FIG. 12.

FIG. 14 is an isometric view of a leg rest portion as used in the adjustable seating system as shown in FIG. 12.

FIG. 15 is an isometric view of a part of a slide plate forming part of a back portion as used in an adjustable seating system as shown in FIG. 12.

### PREFERRED EMBODIMENTS OF THE INVENTION

In accordance with a first embodiment of the invention there is an adjustable seating system 10 for a wheelchair 12. The frame 10 comprises a base portion 14, a seat portion 16, leg rest portion 18, a back portion 20 and arm rests 22.

The base portion 14 comprises a plurality of tubes 24a arranged into a rectangular frame 26. A further tube 24a bisects the rectangular frame 26 at a position close to first short end 28. This tube 24a and the tube 24a forming first short end 28 both have actuator mounts 30 provided thereon. Actuator mount 30a is angled upwards, while actuator mount 30b is angled downwards.

Extending upright from the corners 32 of the rectangular frame 26 are upright tubes 24b, 24c. Upright tubes 24b are provided at first short end 28 of the rectangular frame 26, while upright tubes 24c are provided at a second short end 34 of the rectangular frame 26. Upright tubes 24c are of longer length than upright tubes 24b, such that the upright tubes 24c terminate at a height relative to the rectangular frame greater than the upright tubes 24b.

Flanges 36a, 36b extend between upright tubes 24b and 24c so as to be parallel to longer ends 38 of the rectangular frame 26. Flange 36a is mounted to each pair of upright tubes 24b, 24c a short distance above the rectangular frame 26. Flange 36b is mounted to each pair of upright tubes 24b, 24b at a point just short of the full height of upright tube 24b. The flanges 36a, 36b are mounted to the upright tubes 24b, 24c so as to create side ledges 40.

Flanges 36a, 36b extend past upright tube 24c.

A pair of apertures 42 are provided in each side ledge 40. The first aperture 42a is provided in each side ledge 40 at a point close to first short end 28. The second aperture 42b is provided in each side ledge 40 at a point where the relevant flange 36a, 36b extends past upright tube 24c.

Each pair of apertures 42 arranged on lower side ledge 40a are designed to facilitate the retention of a wheel frame 44 by way of mechanical means (not shown). The wheel frame 44 comprises a substantially “C”-shaped tube 46. Mounted to each end of the “C”-shaped tube 46 is a wheel 48.

A first triangular bracket 50 extend perpendicular from each side ledge 40 at a position adjacent upright tube 24c. The first triangular bracket 50 is arranged such that apex 52 extends towards second aperture 42b. Extending from each apex 52 is a tubular projection 54. The tubular projections 54 extend away from each other relative to each triangular bracket 50.

An additional tube 24d extends between the tops of upright tubes 24c. Each end 56 of tube 24d has a three hinge plates 58a, 58b, 58c mounted thereon.

The seat portion 16 comprises a mounting frame 60 and a sliding frame 62. Extending from each longitudinal side 64 of the mounting frame 60 are a pair of slide block mounts 66. Mounted to each slide block mount 66 is a slide block 68. The slide blocks 68 will be described in more detail below.

Extending from side 70 of mounting frame 60 is a substantially “V”-shaped mounting bracket 72. The “V”-shaped mounting bracket 72 has an interior end 74 and an exterior end 76. The interior end 74 acts as an actuator mount. The exterior end 76 has a plurality of apertures 78 provided therein.

The sliding frame 62 comprises side plates 80, end tubes 82 and actuator support plates 84a, 84b.

Each side plate 80 comprises a box tube 86 and a slide plate 88. The slide plate 88 extends perpendicular to underside 90 of the box tube 86 from a central point thereof. Each slide plate 88 has two longitudinal channels 92 provided therein. Each longitudinal channel 92 is of identical size and shape.

A second triangular bracket 94 is provided at one end 96 of each slide plate 88. The second triangular bracket 94 is arranged such that apex 98 extends above box tube 86. Extending from each side of the second triangular bracket 94 at apex 98 is a ring projection 100.

A first end tube 82a extends between the second triangular brackets 94 at a point proximate longitudinal channel 92b. A second end tube 82b extends between the box tubes 86 at a position above longitudinal channel 92a.

Actuator support plate 84b extends between the box tubes 86 at a position proximate first end tube 82a. In this manner, a first actuator mounting plate 102 is mounted centrally to both the actuator support plate 84b and first end tube 82a.

Actuator support plate 84a extends between the box tubes 86 at a point proximate mid-length of the box tubes 86. In this position the actuator support plate 84a is also located above longitudinal channel 92a.

A second actuator mounting plate 104 is mounted to one side of the actuator support plate 84a.

The sliding frame 62 is connected to the mounting frame 60 by way of slide blocks 68. Each slide block 68 takes the form of an elongated block having a “H”-shaped cross-section. The interconnector (not shown) of each slide block 68 is of identical width and height to that of the longitudinal channels 92a, 92b. In this manner, when connected, the interconnector of each slide block 66 is received within a longitudinal channel 92 with each of the sides (not shown) also making connection with the relevant slide plate 88.

In this embodiment, the slide blocks 68 are made of plastic.

The sliding frame 62 is further connected to the mounting frame 60 by way of seat actuator 106. Seat actuator 106 extends between first actuator mounting plate 102 and interior end 74.

The leg rest portion 18 comprises a connector flange 108, linking arms 110 and a leg rest mounting assembly 112.

The connector flange 108 has a linking mount 114 provided centrally thereon. The linking mount 114 has a plurality of apertures 116a, 116b provide therein. The role of the various apertures 116a, 116b will be described in more detail below.

The connector flange 108 also has an actuator mount 118 provided thereon. The actuator mount 118 extends from the connector flange 108 at a point to one side of the connector flange 108.

The connector flange 108 also provides arm mounts 120. Each arm mount 120 is provided on opposing sides of the connector flange 108.

It is to be noted that each of the linking mount 114, actuator mount 118 and arm mounts 120 all extend from the same side of the connector flange 108.

The leg rest mounting assembly 112 may take any size or shape. However, the leg rest mounting assembly 112 must have arm mounts 122, an actuator mount 124 and an extendable linkage 126.

The arm mounts 122 must be provided to the side periphery of the leg rest mounting assembly 112. In this manner, linking arms 110 connect the connector flange 108 to the leg rest mounting assembly 112 by way of arm mounts 120, 122.

The extendable linkage 126 comprises a cylindrical housing 128 and an extending rod 130. The extending rod 130 is received within the cylindrical housing 128 and is able to move therein in a telescopic manner.

The extending rod 130 has a mounting point 132. The mounting point 132 is designed to allow connection to the connector flange 108 by way of aperture 116b. Thus, the extendable linkage 126 operates as a further point of connection between connector flange 108 and leg rest mounting assembly 112.

A final point of connection between connector flange 108 and leg rest mounting assembly 112 takes the form of leg rest actuator 134. To elaborate, leg rest actuator 134 is connected to, and extends between, actuator mounts 118, 124.

The back portion 20 comprises a mounting frame 136 and a sliding frame 138.

Extending from each lateral side 140 of the sliding frame 138 are a pair of slide block mounts 142. Mounted to each slide block mount 142 is a slide block 144.

The slide block mounts 142 are of identical construction to slide block mounts 66. Similarly, slide blocks 144 are of identical construction to slide blocks 68.

A third actuator mounting point 146 is provided in top short end 148 of sliding frame 138. The actuator mounting point 146 extends towards the mounting frame 136.

The mounting frame 136 comprises side plates 154 and end tubes 156.

Each side plate 154 comprises a box tube 158 and a slide plate 160. The slide plate 160 extends perpendicular to underside 162 of the box tube 158 from a central point thereof. Each slide plate 160 has two longitudinal channels 163 provided therein. Each longitudinal channel 163 is of identical size and shape.

Extending centrally from the bottom short end 150 of mounting frame 136 is an elongated triangular mounting point 152. The elongated triangular mounting point 152 acts as an actuator mounting point for two actuators as will be described in more detail below.

A pivot connector bracket 164 is provided at one end 166 of each slide plate 160. The pivot connector bracket 164 is arranged such that it extends in substantially the same direction as side plate 154. A pivot ring projection 166 is provided in end 168 of pivot connector bracket 164.

In this embodiment, the pivot connector bracket 164 is integrally formed with its corresponding side plate 154.

End tube 156a extends between the box tubes 158 at a point proximate top short end 148 when the sliding frame 138 is attached. Another end tube 156b extends between the box tubes 158 at a point proximate the area where each pivot connector bracket 164 joins its corresponding side plate 154.

A pair of arm connector projections 170 are mounted to each corresponding side plate 154. The arm connector projections 170 are positioned so as to sit underneath longitudinal channel 163a. The role of the arm connector projections 170 will be described in more detail below.

The sliding frame 138 is connected to the mounting frame 136 by way of slide blocks 144. The interconnector (not shown) of each slide block 144 is of identical width and height to that of the longitudinal channels 163a, 163b. In this manner, when connected, the interconnector of each slide block 144 is received within a longitudinal channel 163 with each of the sides (not shown) also making connection with the relevant slide plate 160.

The arm rests 22 have a first portion 172 and a second portion 174. The second portion 174 has a ring mount 176 and a cylindrical mount 178 provided thereon. The cylindrical mount 178 extends from the second portion 174 at a point close to the point of connection between first portion 172 and second portion 174.

Pivotally connected to the ring mount 176 is a first connector piece 180. The end 182 of the first connector piece 180 not connected to the ring mount 176 has a cylindrical projection 184 extending therefrom. This cylindrical projection 184 is positioned such that it extends away from the arm rest 22.

Pivotally connected to the cylindrical mount 178 is a second connector piece 186. The end 188 of the second connector piece 186 not connected to the cylindrical mount 178 has a cylindrical projection 190 extending therefrom. This cylindrical projection 190 is positioned such that it extends away from the arm rest 22. The cylindrical projection 190 terminates in a mounting flange 192.

It is to be noted that due to the differences in heights of the ring mount 176 and the cylindrical mount 178, the first and second connector pieces 180, 186 are able to pivot without interfering with each other.

To assemble the seat portion 16 and the back portion 20 to the base portion 10, firstly, the seat portion 16 is aligned such that ring projection 100 is received between hinge plates 58a, 58b. Secondly, back portion 20 is aligned such that pivot ring projection 166 is received between hinge plates 58b, 58c. A pivot rod (not shown) is then inserted so as to be received within the ring projection 100 and pivot ring projection 166 and fixed in place.

The arm rests 22 are connected to the frame 10 at two points. The first point of connection requires the mounting flange 192 to be received within arm connector projections 170 and fixed in place with an appropriate fastener (not shown). The second point of connection requires cylindrical projection 84 to be positioned so as to receive tubular projection 50.

As has already been disclosed, the invention incorporates a seat actuator 106 and a leg rest actuator 134. The seat actuator 106 is operable to control the longitudinal position of the seat as it slides along longitudinal channels 92. The leg rest actuator 134 is operable to control the rotational position of the leg rest mounting assembly 112 relative to connector flange 108.

However, the invention further incorporates three additional actuators: a seat height actuator 194, a back pivot actuator 196 and a back height actuator 198.

The seat height actuator 194 is connected at one end to actuator mount 30b and at the other end to second actuator mounting plate 104. In this manner the seat height actuator 194 operates to control the rotational position of the seat portion 16 about the pivot rod installed into hinge plates 58.

The back pivot actuator 196 is connected at one side to actuator mount 30a and at the other end to triangular mounting point 152. Like the seat height actuator 194, the back pivot actuator 196 operates to control the rotational position of the back portion 20 about the pivot rod installed into hinge plates 58.

The back height actuator 198 is connected at one end to triangular mounting point 152 and at the other end to third actuator mounting point 146. The back height actuator 198 operates similarly to seat actuator 106 in that it is operable to control the longitudinal position of the backrest as it slides along longitudinal channels 92.

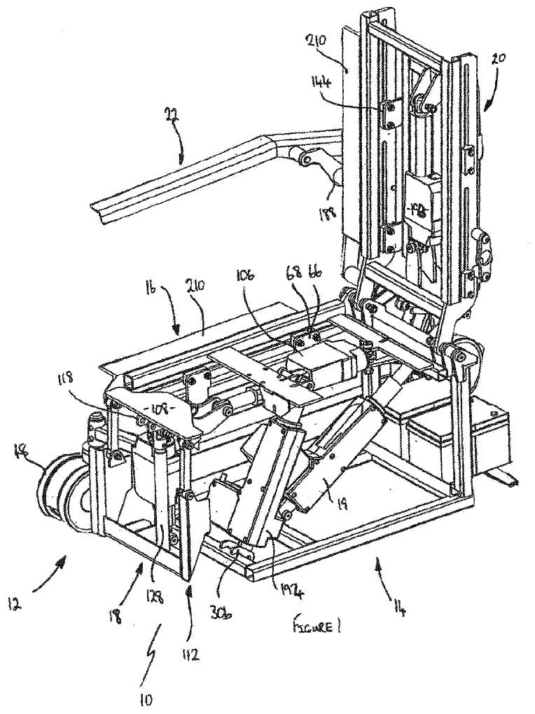

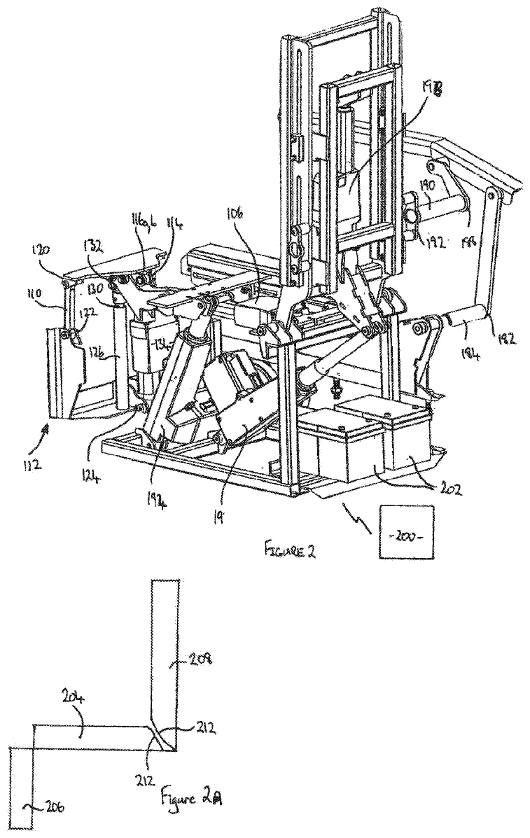

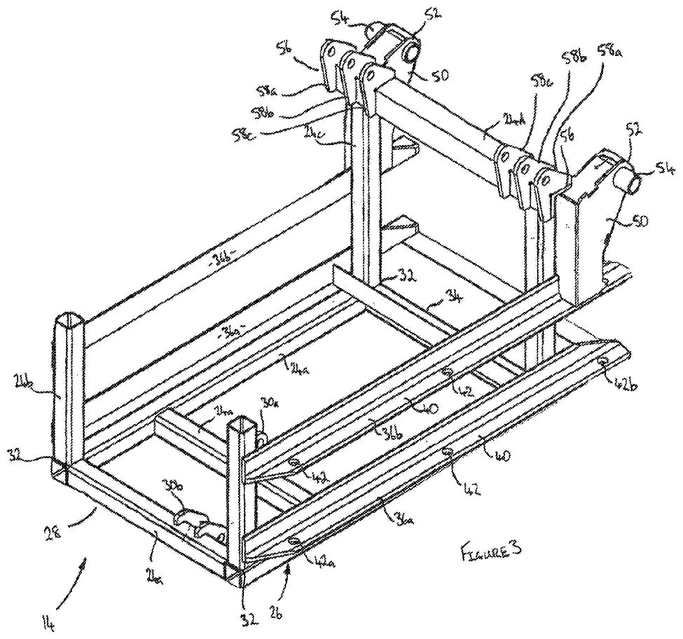

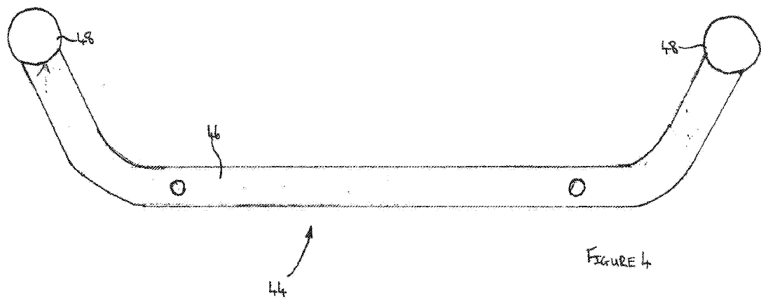

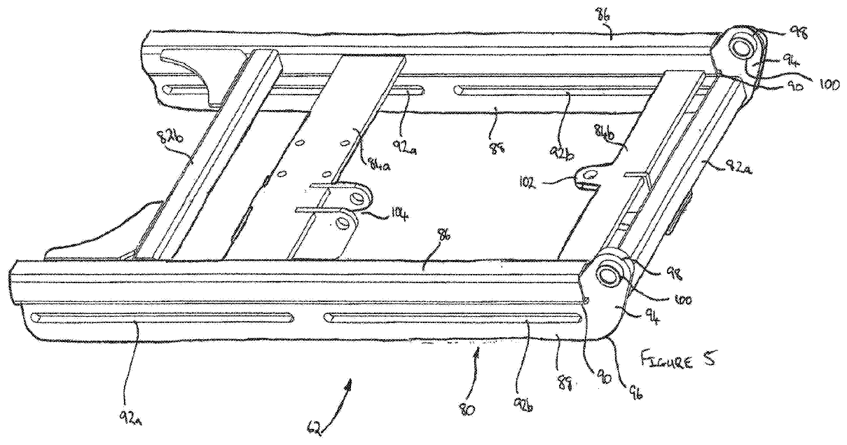

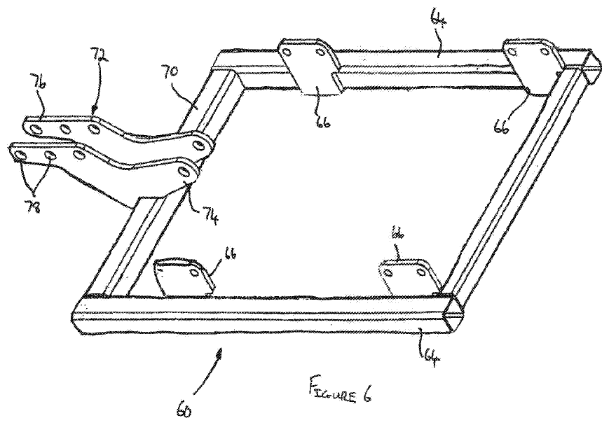

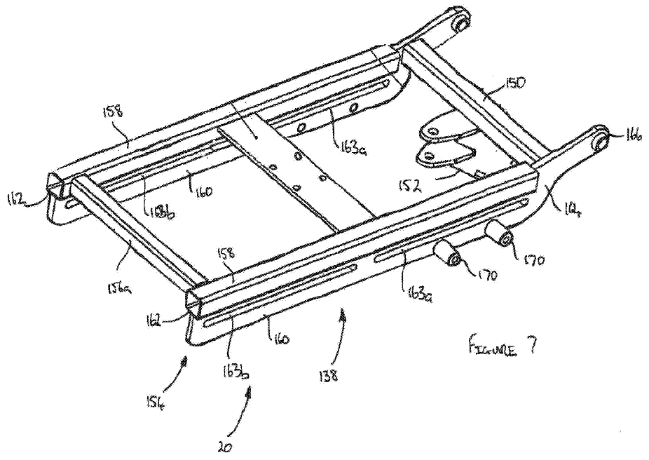

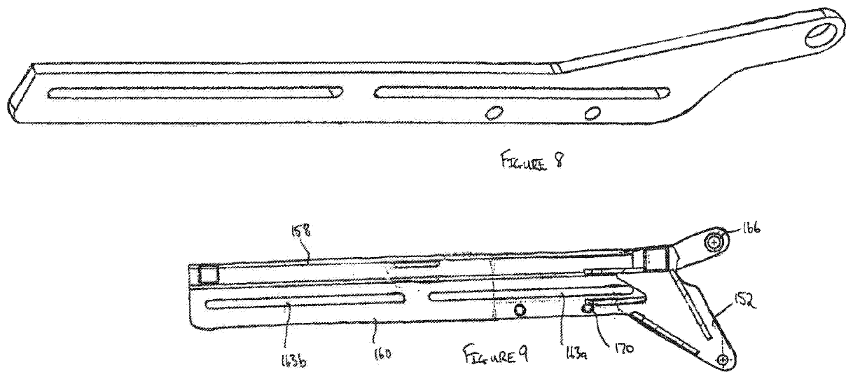

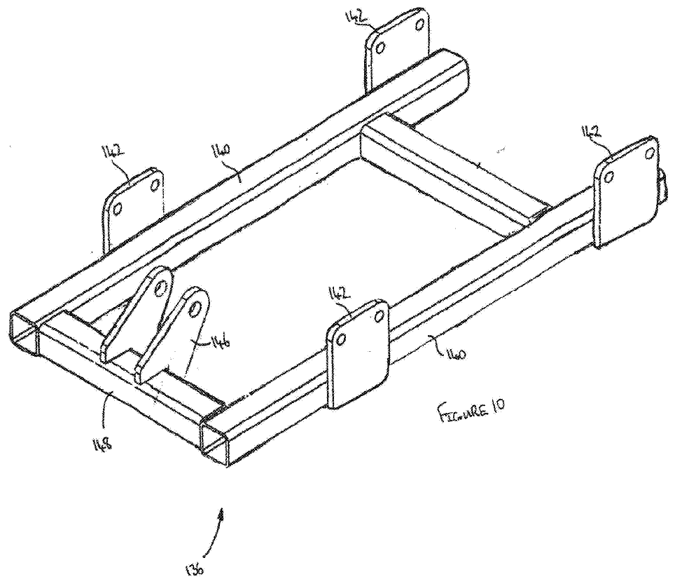

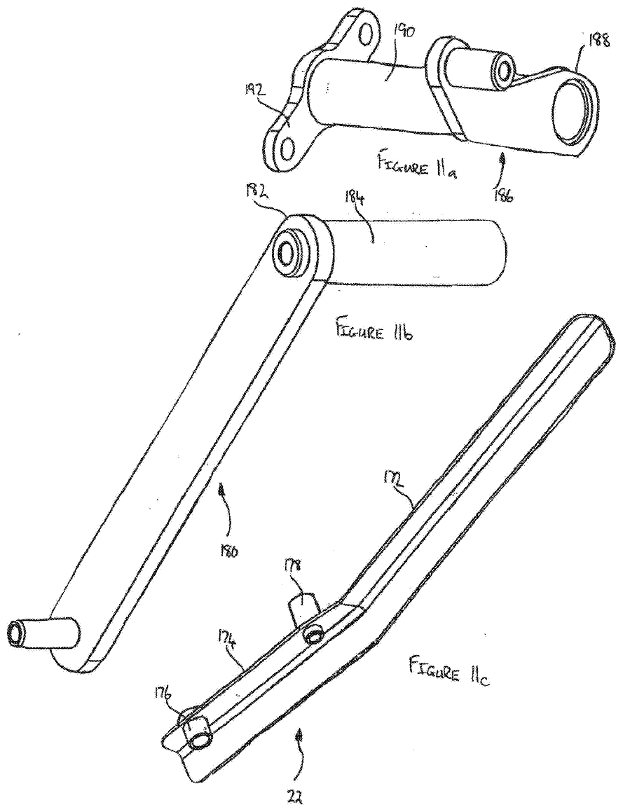

Each of the actuators 106, 134, 194, 196 and 198 is each controlled by way of a control unit 200 and supplied power by way of a power unit 202. The power unit 202 is preferably one or more batteries as shown in FIGS. 1 and 2.

It is to be further noted that the person skilled in the art should readily be able to determine how to fasten upholstery in the form of a seat 204, leg rest 206 and backrest 208 to the frame 10 as described above. However, one method of so fastening is the use of flanges 210 as shown in FIG. 1.

While the leg rest 206 can be made of any material and of any shape as desired, the seat 204 and backrest 208 each have at least one rounded side profile 212. The rounded side profile 212 of the seat 204 must be aligned to face the back portion 20. Similarly, the rounded side profile 212 of the backrest 208 must be aligned to face the seat portion 16. In this manner, the rounded side profiles 212 face each other with minimal gap therebetween (if not touching).

This embodiment of the invention will now be described in the context of its intended use.

A person places themselves into the wheelchair 12 such that their buttocks are in proximity the point where the rounded side profiles 212 of the seat 204 and backrest 208 meet. At this position, the person can then place their legs so that their lower leg is adjacent the leg rest 206 and they are leaning into the backrest 208. Once so positioned, the person operates to select a movement program using the control unit 200.

Upon selecting a movement program by way of the control unit 200, the control unit 200 operates to send control signals to the various actuators 106, 134, 194, 196 and 198 to return to a start position (if not already in that position). Once the actuators 106, 134, 194, 196 and 198 are in the start position, the control unit 200 operates to send further control signals in accordance with the selected movement program. As the actuators 106, 134, 194, 196 and 198 are drawing power from the power supply 202, the actuators 106, 134, 194, 196 and 198 are able to respond to the control signals as and when received.

For the purposes of this illustration, the selected movement program will be deemed to be a simple continuous movement program.

To commence the continuous movement program, the control unit 200 initially sends:
an extension control signal to actuator 194. This causes actuator 194 to extend and thereby cause seat portion 16 to rotate clockwise about pivot rod installed into hinge plates 58.
a retraction control signal to actuator 196. This causes actuator 196 to retract and thereby cause back portion 20 to rotate clockwise about pivot rod installed into hinge plates 58.

Once actuators 194, 196 have reached their maximum extension/retraction as desired by the issued control signals, the control unit 200 operates to repeatedly issue two sets of control signals to actuators 194, 196 and 198. The first set of control signals issued are to:
cause actuator 194 to retract at a set movement rate for a short period of time. This causes seat portion 16 to rotate counter clockwise about pivot rod installed into hinge plates 58;
cause actuator 196 to extend at a set movement rate for the same short period of time. This causes back portion 20 to rotate counter clockwise about pivot rod installed into hinge plates 58.
cause actuator 198 to extend at a minimal movement rate for the same short period of time. This causes backrest 208 to make minimal movements towards the seat 204.

The second set of control signals issued are to:
cause actuator 194 to extend at a set movement rate for the same short period of time. This causes seat portion 16 to rotate clockwise about pivot rod installed into hinge plates 58;
cause actuator 196 to retract at a set movement rate for the same short period of time. This causes back portion 20 to rotate clockwise about pivot rod installed into hinge plates 58.
cause actuator 198 to retract at a minimal movement rate for the same short period of time. This causes backrest 208 to make minimal movements away from the seat 204.

It is to be noted by the person skilled in the art that the signals issued to actuators 194, 196, 198 in each set of control signals are issued simultaneously. This means that there is co-ordinated movement between each actuator 194, 196, 198. This is particularly important in the case of actuator 198 as its movement acts to counteract movement of the backrest 208 by actuator 196 relative to movement of the seat by actuator 194 which would otherwise cause shear.

Furthermore, while the control program is running, as the arm rests 22 are able to pivot about their connections to the other elements of the frame 10, the arm rests 22 always remain substantially horizontal regardless of the position of the backrest 208 and/or seat 204.

The person skilled in the art should also realise that the signal generated by the control unit 200 must be customisable for two reasons. The first is that the upholstery forming the seat 204, leg rest 206 and backrest 208 may differ in sizes between chair frames, thus requiring calibration of the program to ensure that the size differences do not inadvertently restrict movement of the frame as intended or potentially create a gap that could facilitate shear. The second reason is that a patient may need a specific continuous movement program to facilitate their rehabilitation or care that is not routine and this is further detailed below.

In accordance with a second embodiment of the present invention, where like numerals reference like parts, there is a frame (not shown) for a wheelchair 12. The frame is identical in construction to that described in the first embodiment. The difference underlying this embodiment relates to the control unit 200 and the actuators 106, 134, 194, 196 and 198.

In this second embodiment, each of the actuators 106, 134, 194, 196 and 198 are able to wirelessly communicate with the control unit 200. In this embodiment, the control unit 200 communicates with each actuator 106, 134, 194, 196 and 198 using the Bluetooth® wireless communication protocol. Furthermore, the control unit 200 takes the form of a tablet.

This embodiment will now be described in the context of its intended use.

A person places themselves into the wheelchair 12 while holding the tablet. The person's position in the wheelchair 12 is to be such that their buttocks are in proximity the point where the rounded side profiles 212 of the seat 204 and backrest 208 meet. At this position, the person can then place their legs so that their lower leg is adjacent the leg rest 206 and they are leaning into the backrest 208. Once so positioned, the person operates to select their user profile using the tablet.

Upon selecting their user profile by way of the control unit 200, the control unit 200 operates to send control signals to the various actuators 106, 134, 194, 196 and 198 to return to a start position (if not already in that position). Once the actuators 106, 134, 194, 196 and 198 are in the start position, the control unit 200 operates to send further control signals in accordance with the movement program(s) that have been set up in the user profile.

As the specifics of the movement program(s) that may be set up in a user profile are numerous and not necessary for an understanding of this particular embodiment, they will not be described in more detail here.

While each continuous movement program(s) executes, the control unit 200 further operates to gather additional data. This additional data may include, as examples, any of the following:
duration of operation;
number of repetitive cycles;
details of any interruption to a continuous movement program; and
diagnostic and troubleshooting information.

This additional data can then be communicated to a central repository at a set time of day along with details of the patient as included in their user profile. In this manner, an automatic record regarding the continuous movement programs can be uploaded for inclusion as part of the patient's main health records.

The person skilled in the art would readily recognise that the number of continuous movement programs is potentially endless, but movement programs of benefit to a patient will be dictated by factors including height, weight, physical abnormalities and/or injuries and current health. Thus, it is not generally possible to create a single movement program that seeks to address the health needs of a patient as well as the issue of shear.

That said, the applicant has managed to create a movement program that addresses a range of heights and other factors which they believe also reduces the possibility of shear. This movement program sees the angle between the backrest 208 and the seat 204 set to 150°, with the seat height set to an angle of 5°. Simultaneously, the seat 204 is moved 13% of its maximum available movement, while the backrest 208 is moved 70% of its maximum available movement. The leg rest 206 is set to an angle of 70°.

As can be appreciated, a key issue with an elderly population is dementia and other like health issues that can cause disorientation. A person suffering from such an affliction can easily be startled by sudden or continuous movement of an automated adjustable seating frame such as that described in the above embodiments. For this reason, the control unit 200 may implement a discontinuous movement program.

A discontinuous movement program sees one or more actuator 106, 134, 194, 196, 198 operate for a short period of time (potentially five (5) seconds) at a slow movement pace. This results in small shifts in position of the frame 10, 200 on each actuation which would not startle such a person if in a disoriented state, while still allowing for full changes in position over a longer timeframe.

in accordance with a third embodiment of the invention where like numerals reference like parts, there is a frame 300 for a wheelchair 12. The frame 300 is identical in construction to that described in the first embodiment, subject to the following differences.

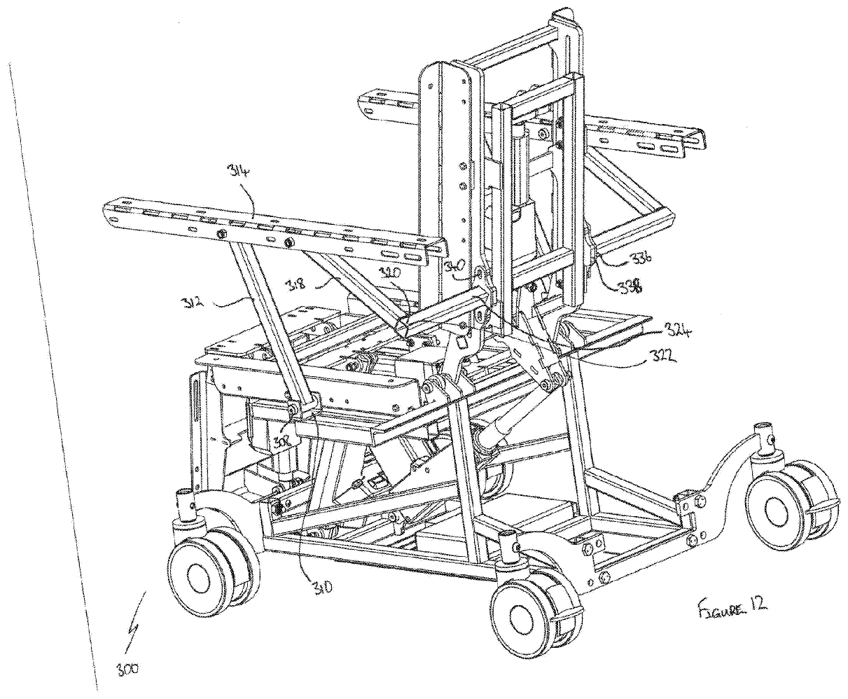

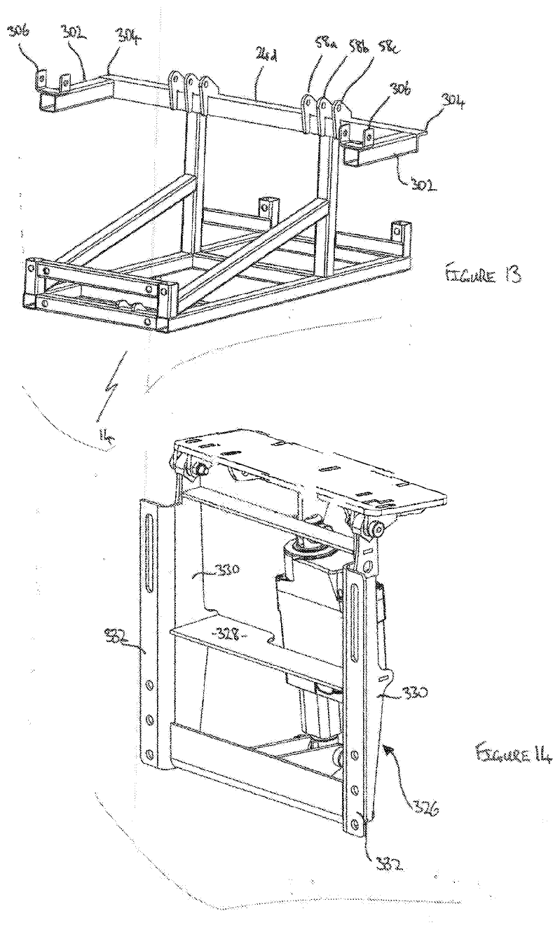

The base portion 14 is structurally modified as shown in FIG. 12. While the majority of these modifications are to improve the overall structural nature of the frame 300 and therefore have no impact on the invention, additional tube 24d has been modified as shown in more detail in FIG. 13 and this impacts on the invention.

Specifically, additional tube 24d now extends past the three hinge plates 58a, 58b, 58c to take up the space partially occupied previously by the first triangular brackets 50. In doing so, it is to be noted that the first triangular brackets 50 are omitted in this embodiment of the invention.

Extending perpendicular to the additional tube 24d is a pair of arm support retention tubes 302. Each arm support retention tube 302 extends from an end 304 of the additional tube 24d. The arm support retention tubes 302 each extend away from the additional tube 24d in the same direction, thereby ensuring that the arm support retention tubes 302 are substantially parallel to each other.

Mounted to the top of each arm support retention tube 302 is an arm support pivot flange 306. A pin 308, extending through the support pivot flange 306 and a first end 310 of first arm member 312, allows first arm member 312 to pivot relative to its associated arm support retention tube 302. Second end 314 of first arm member 312 is similarly pivotally connected to arm 314 at a point approximately one third of its length.

Also similarly pivotally connected to arm 314 at a point approximately half its length is a first end 316 of second arm member 318. Second end 320 of second arm member 318 is fixedly connected to an end 322 of back arm mounting strut 324. The back arm mounting strut 324 will be explained in more detail below.

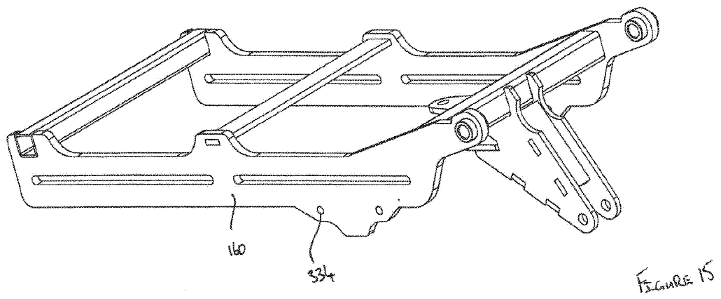

The leg rest portion of frame 300 is also modified as shown in FIG. 14. As can be seen in this figure, some of the modifications are to improve the overall structural nature of the frame 300 and therefore have no impact on the invention. However, in this embodiment, linking arms 110 are omitted in favour of a larger leg rest mounting assembly 326.

The larger leg rest mounting assembly 326 is structurally similar to leg rest mounting assembly 112, but with an added dividing strut 328. Similarly, side struts 330 incorporate a return flange 332 to facilitate attachment of leg rest upholstery (not shown).

As the linking arms 110 have been omitted, the larger leg rest mounting assembly 326 is pivotally connected direct to connector flange 108. The means by which the leg rest mounting assembly 326 is pivotally connected to the connector flange 108 in a similar manner to the pivot connections already described.

The back rest portion 20 remains essentially unmodified. However, arm connector projections 170 are omitted in favour of arm connector retaining apertures 334 and an increase in the size of the side plate 160 at the area surrounding the arm connector retaining apertures 334.

The back arm mounting strut 324 has a first end 322 as indicated above and a second end 336. Extending from the second end 336 is a mounting plate 338. The mounting plate 338 has a pair of apertures 340 provided therein. In this manner, a fastener (not shown) that extends through apertures 340 and arm connector retaining apertures 334 securely connects the back arm mounting strut 324 to side plate 160.

Additional modifications have been made to this embodiment of the invention in the form of using actuators 194, 196, 198 having integrated potentiometers (not shown). The integrated potentiometers are in data communication with the control unit 200, so as to provide the control unit 200 with potentiometer feedback during activation of its respective actuator 194, 196, 198.

A further modification in this embodiment is the inclusion of a microswitch (not shown) between the seat portion 16 and the back portion 20. Like the integrated potentiometers, the microswitch is in data communication with the control unit 200. The functional role of the microswitch will be described in more detail below.

This embodiment of the invention will now be described in the context of its intended use. In this respect, the method of operation is identical to that described in respect of the first embodiment, subject to the following points.

During the course of the continuous movement program, the control means 200 is constantly being fed potentiometer measurements from the actuators 106, 134, 194, 196, 198. These measurements are used by the control means to determine if any part of the chair 12, incorporating frame 300, makes contact with an object. If this occurs, depending on the resistance provided by and/or duration of the contact, the control means 200 may cancel the current continuous movement program and take alternative action. Examples of possible alternative action are to keep the chair 12 stationary at its position of contact or return the chair 12 to a neutral position.

Additionally, movement caused by actuator 196 to the back portion 20, and movement caused by actuator 194 to the seat portion 16 has an impact on the position of the arm 314. To elaborate, the first arm member 312 is pivotally connected to both the arm 314 to the base portion 14. The second arm member 318, however, is only pivotally connected to the arm 314—it being fixedly connected at the other end to the back portion 20. This means that the impact of longitudinal movement of the seat portion 16 on the arm 314 is counteracted by appropriate counter rotation of the first arm member 312. At the same time, the impact of rotational movement of the back portion 20 is translated by appropriate rotation of the second arm member 318. Specifically, the rotational arcs of the first and second arm members 310, 312 ensure that the vertical height of each end of the arm 314 remains equal at all times.

The third point of difference in the operation of a chair 12 incorporating frame 300 is the continuous monitoring of the microswitch by the control means 200. During movement of the back portion 20 and the seat portion 16, there is the remote possibility that part of the patient's body may enter the gap created therebetween, or that some other object may become lodged in between. The presence of such a part or object is detected by the microswitch and relayed back to the control means 200. The control means 200 then operates to reverse the current direction of movement of the back portion 20 and seat portion 16 for a short period of time so as to allow the part or object to be removed from the created gap.

It should be appreciated by the person skilled in the art that the above invention is not limited to the embodiment described. In particular, the following modifications and improvements may be made without departing from the scope of the present invention:
While the invention has been described in the context of the automated adjustable chair frame 10 forming part of a wheelchair 12, there is no reason why the adjustable chair frame 10 could not form part of a standard or fixed chair.
Similarly, while the invention has been described as being particularly suited to the elderly and infirm, the applicant can see no reason why the invention can not be applied to other situations where a person may need to be reclined for long periods of time. For instance, the invention could be incorporated into an operating chair used by medical professionals when performing medical exams or operations of long duration.
The backrest 208 may have speakers (not shown) embedded therein at a position proximate a patient's expected head height. The speakers can be controlled by the control unit 200 to facilitate the additional delivery of music therapy.
The leg rest portion 18 may be omitted in one variation. Alternatively, the leg rest portion 18 may be fixed in a static position.
The control unit 200 may take the form of a smartphone, portable computer or other processing device capable or wireless communication with actuators 106, 134, 194, 196, 198.
The frame 10 may further provide means for detecting the presence and/or absence of a person, for example through appropriate pressure sensors in the seat portion 16 or back portion 20. In such an arrangement, the control unit 200 may only commence operation of a movement program on detection of a person sitting on the seat 204. Alternatively, the control unit 200 may cease operation of a movement program on detecting that there is no one sitting on the seat 204. Furthermore, on detecting that there is no one sitting on the seat 204, the control unit 200 may operate to initiate an alarm to a care-giver.
The control unit 200 may further incorporate environmental sensors. The environmental sensors can monitor the surrounding environment for obstructions or other issues that may make operation of the current movement program dangerous either for the person in the wheelchair 12 or third parties.
The control unit 200 may take the form of a specialised tethered controller.
The frame 10, 300 may have apertures provided therein. The inclusion of these apertures has various benefits. Firstly, the apertures assist in reducing the overall weight of the frame 10, 300. Secondly, in a situation where a patient may be incontinent, or merely spills a liquid they are seeking to consume, the apertures operate as drainage points for the frame 10, 300. In doing so, the potential damage caused by the associated liquid can be minimised. Finally, the apertures effectively operate as vents and thereby assist in preventing the build-up of potential environmental contaminants, such as dust.
Power unit 202 may take the form of a removable battery unit. In such an arrangement, when not in use—for example after the patient has been returned to their bed—the battery unit is removed for charging at a central charging location. Once charged, the battery is returned to the frame 10, 300 from which it was removed to provide required power to the invention as already described. it is also to be noted that by having a removable, rechargeable power unit 202, the power unit 202 can be “hot-swapped” as is necessary to ensure practically continuous operation of the invention where needed.
While the invention has been described in the context of the upholstered seat 204 and backrest 208 having rounded side profiles 212, it is to be appreciated that this is merely the preferred arrangement. Other side profiles that can rotate relative to each other without creating a large gap therebetween may be used in place of the rounded side profile 212.
The leg rest mounting assembly 112, 326 may be further modified such that it performs the role of a foot rest or is further modified to include additional elements that can perform the role of a foot rest.

It should be further appreciated that even more embodiments of the invention incorporating one or more of the aforementioned features, where such features are not mutually exclusive, can be created without departing from the invention's scope.

1.-37. (canceled)

38. An automated adjustable seating system comprising:
a seat, the seat incorporating a first sliding frame and seat upholstery attached to the sliding frame;
a backrest, the backrest incorporating a second sliding frame and back upholstery attached to the sliding frame;
a set of actuators; and
a control system
where the set of actuators includes an actuator for adjusting the angle of the seat relative to the horizontal, an actuator for adjusting the longitudinal position of the first sliding frame; an actuator for adjusting the angle of the backrest relative to the vertical and an actuator for adjusting the longitudinal position of the second sliding frame and where when the control system operates to simultaneously control the actuator that adjusts the longitudinal position of the first sliding frame in a manner that counteracts the change in seat position caused when the control system operates to control at least one of the following so as to minimise any gap formed between the seat upholstery and back upholstery:
the actuator for adjusting the angle of the seat relative to the horizontal; and
the actuator for adjusting the angle of the backrest relative to the vertical.

39. An automated adjustable seating system according to claim 38, where the control system also operates to simultaneously control the actuator that adjust the longitudinal position of the first sliding frame in a manner that counteracts the change in seat position caused when the control system operates to control the actuator for adjusting the longitudinal position of the second sliding frame so as to minimise any gap formed between seat upholstery and back upholstery.

40. An automated adjustable seating system according to claim 38, further comprising a leg rest having leg rest upholstery attached thereto and where the set of actuators further includes an actuator for adjusting the angle of the leg rest relative to the vertical and where the control system also operates to simultaneously control the actuator that adjusts the longitudinal position of the first sliding frame in a manner that counteracts the change in seat position caused when the control system operates to adjust the angle of the leg rest relative to the vertical and/or the so as to minimise any gap formed between leg rest upholstery and seat upholstery.

41. An automated adjustable seating system according to claim 38, further comprising a leg rest having leg rest upholstery attached thereto and where the control system also operates to simultaneously control the actuator that adjusts the longitudinal position of the first sliding frame in a manner that counteracts the change in seat position caused when the control system operates to adjust the angle of the leg rest relative to the vertical so as to minimise any gap formed between leg rest upholstery and seat upholstery.

42. An automated adjustable seating system according to claim 38, where the backrest and seat are connected at a pivot point and where that adjustment of the angle of the backrest is made with reference to the vertical at the pivot point and where the adjustment of the angle of the seat is made with reference to the horizontal at the pivot point and where the seat upholstery has a first side and the back upholstery has a second side, the first side and the second side arranged to face each other and the profile of the first and second sides being such that the sides may rotate relative to each other without creating a substantial gap therebetween.

43. An automated adjustable seating system according to claim 42, where either the first and/or second side, or both, has a rounded profile.

44. An automated adjustable seating system according to claim 38, further incorporating a pair of seat arms, each seat arm rotationally connected to the seat and the backrest so that the arm is self-levelling regardless of the position of the seat relative to the backrest.

45. An automated adjustable seating system according to claim 44, where the seat arm is connected to the seat by way of a first rotational arm and connected to the backrest by way of a second rotational arm, the rotational arcs of the first rotational arm and second rotational arm being such as to ensure self-levelling of the arm regardless of the position of the seat relative to the backrest.

46. An automated adjustable seating system according to claim 38, where at least one actuator in the set of actuators incorporates a potentiometer, the potentiometer in data communication with the control system and where the control system operates to return at least one actuator in the set of actuators to a first set position on receiving a signal form a potentiometer indicating that the frame has made contact with an external object.

47. An automated adjustable seating system according to claim 46, where at least one of the actuators or potentiometer is in wireless control communication with the control system.

48. An automated adjustable seating system according to claim 38, further comprising a leg rest rotationally connected to the seat, one of the actuators in the set of actuators operable to adjust the angle of the leg rest relative to the seat and where the leg rest further incorporates a foot rest.

49. An automated adjustable seating system according to claim 38, further comprising a microswitch located between the seat and the backrest, the microswitch in data communication with the control system and where the control system operates to return the seat, the backrest or both the seat and the backrest to a predetermined position on receiving a signal from the microswitch indicating that something is lodged in a gap between the seat and the backrest.

50. An automated adjustable seating system according to claim 38, further comprising speakers in data and control communication with the control system, the speakers located within the back upholstery at a position proximate the expected head position of the average seated portion.

51. An automated adjustable seating system according to claim 38, where the control system is one or more of the following: a tablet; a smart phone; a notebook or laptop computer; a dedicated handset controller.

52. An automated adjustable seating system according to claim 38, where the control system is operable to control the set of actuators to do one or more of the following: limit the angle between the seat upholstery and the backrest upholstery to 150°; limit the seat height to an angle of 5°; move the first sliding frame to a maximum of 13% of its maximum available movement; move the second sliding frame to a maximum of 70% of its maximum available movement; limit the angle between the leg rest and the seat upholstery to an angle of 70°.

53. An automated adjustable seating system according to claim 38, where at least one of the seat upholstery or the backrest upholstery has presence detecting means incorporated therein for detecting the presence, or absence, of a seated person, the presence detecting means being in data communication with the control system and where the control system operates to notify an external party on receiving a signal from the presence detecting means indicating that a previously seated person is no longer seated in the seating system.

54. An automated adjustable seating system according to claim 38, where the control system operates to control the set of actuators to perform one or more of the following: a customised set movement program; a continuous preset movement program; a discontinuous preset movement program.

55. An automated adjustable seating system according to claim 54, where the customised set movement program is customised in respect of one or more of the following factors: duration of operation; range of movement; frequency of movement; type of movement; number of repetitive movement cycles; details of any interruptions to the set movement program.

56. An automated adjustable seating system according to claim 54, where the control system is periodically operable to send details of each movement program executed by the automated adjustable seating system to a central repository for association with a patient's health record.

57. An automated adjustable seating system according to claim 38, where the automated adjustable seating system forms part of a wheelchair.
